(19) United States
(12) Patent Application Publication
(10) Pub. No.: US 2007/0004842 A1
(43) Pub. Date: Jan. 4, 2007

(54) Polymer nanocomposite blends

(76) Inventors: Daniela Tomova, Rudolstadt (DE); Stefan Reinemann, Rudolstadt (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/555,910

(22) PCT Filed: Apr. 2, 2004
(86) PCT No.: PCT/DE04/00744

§ 371 Date: Nov. 7, 2005

(30) Foreign Application Priority Data
May 5, 2003 (DE) 10320695.7
Mar. 3, 2004 (DE) 102004011019.0

(51) Int. Cl. C08K 9/04

(52) U.S. Cl. 524/445; 524/514

(57) ABSTRACT

Polymer nanocomposite blends of at least two polymers and nanodispersed delaminated phyllosilicates and methods for their production. The polymer nanocomposite blends contain: a) polyamide (PA) from 55 to 95 percent by weight, b) polypropylene (PP) from 4 to 40 percent by weight, c) nanodisperse phyllosilicates from 1 to 9 percent by weight, d) up to 10% by wt. carboxylated polyolefins, particularly copolymers of ethylene with unsaturated carboxylic acids, so that the weight ratios of the compositions always add up to 100 percent by weight. Common stabilizers and fillers may be contained as additives.

The invention relates to polymer nanocomposite blends of at least two polymers and nanodispersed delaminated phyllosilicates. The phyllosilicate is a modified natural sodium montmorillonite, hectorite, bentonite, or synthetic mica. The invention also relates to a method of producing these nanocomposites and their use. It is the object of this invention to produce cost-efficient nanocomposites on polyamide basis with improved properties such as high rigidity even in their conditioned state and resistance to thermal oxidation.

Nanocomposites on polyamide as well as polyolefin basis are becoming more and more attractive compared to conventional composites with glas films and minerals respectively with a similar property profile because they help reduce weight. Composites of this type are seen as materials for injection-molded parts with widespread uses in vehicle and aircraft construction, electrical and electronic engineering, equipment and medical engineering.

Property improvement is mainly due to the capability of the phyllosilicate layers to expand (intercalate) or to completely separate from each other (exfoliation). This creates an enlarged surface of the filler material and an enlarged boundary surface with the matrix polymer. To achieve intercalation or exfoliation when producing polymer nanocomposites, the phyllosilicates are modified by cation exchange with organic compounds and thus made organophilic. They are also referred to as organoclays. In addition interactions or interfaces with the matrix polymer are required.

Working organically intercalated phyllosilicates into polymers by in-situ polymerization or melt compounding has been described in several patent documents and is mostly associated with an improvement of the mechanical and barrier properties as well as thermostability [U.S. Pat. No. 4,739,007, WO0034180].

The in-situ polymerization of ε-caprolactam in the presence of organophilically modified clay has been described as early as in 1988 [U.S. Pat. No. 4,739,007]. Working organoclays into polyethylene terephthalate (PET) by melt compounding resulted in an improved barrier against oxygen [WO 0034180].

Polyamide nanocomposites with a second polymer component are also known in principle. Working brominated rubber [U.S. Pat. No. 6,060,549] or polypropylenes grafted with maleic anhydride [X. Liu et al. Polymer 42, 2001, pp. 8235-8239] into in-situ polymerized polyamide 6/Na-montmorillonite-nanocomposites resulted in improved impact strength but reduced mechanical strength of the polyamide. Another finding was reduced water absorption depending on the PP-g portion in the mixture.

Polyamide composites with an increased flexural modulus and dimensional stability during water absorption but having the disadvantage of reduced strength have also been described [EP1076077]. The composites were compounded in the melt with twin-screw extruders and contain 2 to 40 percent by weight of ethylene butylacrylate grafted with maleic anhydride or of polypropylene grafted with maleic anhydride and 0.3 to 30 percent by weight of synthetic phyllosilicate modified with triazine.

EP0352042 also describes polyamide nanocomposites with one or two polymer components. For example, a polyamide nanocomposite prepared in-situ by melt compounding was modified with an ethylene methacrylate Zn⁺ ionomer to resist impact. But losses in stability and rigidity were detected.

In-situ polymerized polyamide 6 nanocomposites that were compounded in the melt with a modifier for impact resistance (butyl acrylate, methyl acrylate rubber or mixtures thereof) are described in DE19854170. The authors also claim in-situ polymerization of PA 6 in the presence of organic phyllosilicates and the synthetic rubber component. These composites had a clay content of 3.7 percent by weight, rubber content of 3 percent by weight and a very high modulus of elasticity (5420 MPa), good impact resistance (Charpy 1eU 112 kJ/m² but a low breaking elongation of 2.9%. The phyllosilicates used were modified with di-2-hydroxyethylmethyl stearyl amine.

Patent document U.S. Pat. No. 5,206,284 claims polypropylene compounds that contain a modified PP (PP-g-MA), a polyamide nano-composite (MPA) prepared in situ with 2% organoclay (montmorillonite modified with aminododecaic acid), an ethylene-alpha-olefin rubber or a modified ethylene-alpha-olefin copolymer such as EPR-g-MA or SEBS-g-MA. The PP-g-MA/PP/MPA composite at a 30/10/60 weight ratio had a flexural modulus of 26000 kg/cm² (2550 MPa), bending strength of 770 kg/cm² (75 MPa), yield stress of 450 kg/cm² (45 MPa) and thermostability—HDT@0.45 MPa of 150° C. Stability, rigidity, and strength declined when the PP portion was increased.

JP10279752 claims a composition consisting of 40 to 99.9 percent by weight polyolefin grafted with carboxylic acid or anhydride, 0.5 to 40 percent by weight polyamide, and 0.01 to 20 percent by weight phyllosilicate with an improved oxygen barrier.

Tjong, S. C.; Meng, Y. Z.; Xu, Y., [J. Applied Polymer Science (2002), 86(9), pp. 2330-2337] described a clay modification process by maleic anhydride for producing PA 6/PP-vermiculite nanocomposites. PP and maleinated vermiculite were first compounded in the melt, and the mixture was subsequently processed by injection molding together with PA 6. An increase in the tensile modulus from 995 MPa for pure PA 6 to 1397 MPa in the nanocomposite having a PP/vermiculite content of 31 percent by weight (8% vermiculite) was observed, with strength having remained unchanged and elongation having declined strongly.

Hua Wang et al. [“Processing and Properties of Polymeric Nano-Composites” Polym. Eng. Sci. 41, 11(2001), pp. 2036-2046] studied nylon 6/PP blends to which approx. 10 percent by weight of clay were added. Refinement of the blend morphology by adding phyllosilicates was observed using a scanning electron microscope. It was found that the modulus of elasticity had increased, which is due to the high clay content, and dramatically reduced strength. Compatibilization with PP-g-MA resulted in a drop in rigidity and had little or no positive effect on strength.

Polyamides fulfil high-quality functions as fibers, foils or components in the wider sense of the term. As they tend to absorb water, extension of their applicability is limited. For example, PA 6 absorbs 3% of water at 23° C. and 50% humidity, and up to 9.5% at 100% relative humidity. The intercalated water is known to influence basic mechanical parameters considerably.

It is known that water absorption can be reduced in blends of polyamide and polyolefins depending on polyolefin content [L. Bottenbruch, R. Binsack; Kunststoffhandbuch; Carl Hanser Verlag, München 1998]. It is therefore usually inevitable to perform a compatibilization using functionalized polyolefins such as block or graft copolymers and the associated influencing of interfacial adhesion.

But this procedure has its setbacks. Using compatibilizers such as functionalized polyolefins and copolymers mostly has a softening effect and results in reduced strength and rigidity.

Polyamides are also sensitive to high working temperatures. It is known that polyamides suffer thermooxidative damage if stored at air temperatures even below their melting point. The polyamides lose their physical properties depending on storage time and temperature. This phenomenon is known as oven aging and is not related to thermal degradation that can occur at temperatures above the melting point. The property of polymers to maintain their mechanical strength, toughness, etc. for longer periods of time is called thermostability which we still call thermal or thermooxidative stability in this document. Heat stabilizers, glass fibers, and other polymers such as polyphenylene ether to improve the thermal stability of polyamides.

The most common methods used to determine thermal properties such as HDT (heat deflection temperature) or DMTA (dynamic mechanical thermal analysis) primarily provide information about short-term stability of materials at high temperatures. The time-dependent influence of thermal oxidation and the associated deterioration of properties cannot be determined satisfactorily in this way. A statement on the thermal stability of polyamide nanocomposites has been based on an HDT increase or the storage modulus at the respective temperature or a glass transition temperature shift (DMTA measurement).

The studies performed on long-term stability revealed that polyamide 6/clay nanocomposites show no thermostability in air at temperatures over 100° C. Thermal oxidation on the surface of the nanocomposite is much faster than that of the polyamide itself, which results in a dramatic drop in strength and damages the surface quality (see the properties of PA nanocomposites listed in Table 4).

It is the object of this invention to maintain the favorable properties of polyamide such as rigidity in its conditioned state and to achieve good thermooxidative stability in conjunction with reduced density as compared to conventional reinforcement of glass or minerals and to reduce costs as compared to pure PA 6/clay nanocomposites.

According to the invention, this object is surprisingly achieved by polymer nanocomposite blends containing
a) polyamide (PA) from 55 to 95 percent by weight,
b) polypropylene (PP) from 4 to 40 percent by weight,
c) nanodisperse phyllosilicates from 1 to 9 percent by weight, and
d) (optionally) up to 10 percent by weight, preferably from 0.1 to 1.9 percent by weight of carboxylated polyolefins, in particular copolymers of ethylene with unsaturated carboxylic acids
   so that the weight ratios of the compositions always add up to 100 percent by weight. Common stabilizers and fillers may be contained as additives.
   Component a) Polyamide

Polyamides are produced by a condensation reaction of lactamen with a ring that has more than three members and/or ω-amino acid(s) or at least one diacid and at least one diamine. The polyamide resins produced by polycondensation are polyamide polymers or copolymers. The polyamide resin is selected from the group consisting of homopolyamides, copolyamides and mixtures thereof, and these polyamides are either semicrystalline or amorphous.

Examples of monomers include α-caprolactam, α-aminocaproic acid, 11-aminoundecanoic acid, 9-aminononanoic acid, and α-piperidone. Examples of diacids include adipic acid, sebacic acid, dodecanoic diacid, glutaric acid, terephthalic acid, 2-methyl terephthalic acid, isophthalic acid, naphtaline dicarboxylic acid. Examples of diamines include tetramethylene diamine, hexamethylene diamine, nonamethylene diamine, decamethylene diamine, undecamethylene diamine, dodecamethylene diamine, p-aminoaniline, and m-xyloldiamine.

The polyamides are preferably selected from the group consisting of polyamide (nylon) 6 or polyamide (nylon) 6/66 with a content of 0 to 20% polyhexamethylene adipamide.

A polyamide 6 with a solution viscosity of 2.2 to 4.0 preferably 2.4 to 3.5, measured in a 1% solution of 96% sulfuric acid at 23° C., is particularly suited for the polymer nanocomposite blends of the invention.

Component b) Polypropylene

Homopolymers or statistical copolymers or block copolymers of propylene with one or several olefins such as ethylene and linear and/or branched C₄ to C₁₀ 1-olefins are used as polypropylenes. It is practical to use poly-propylene homopolymers and block copolymers with a low ethylene content.

The preferred component b) is a polypropylene with a melt-flow index from 1 to 110, from 5 to 30 ccm/10 min (230° C./2.16 kg).

Component c) Nanodisperse Phyllosilicates

The preferred nanodisperse phyllosilicate is a natural sodium montmorillonite, hectorite, bentonite, or synthetic mica with a cation exchange capacity of 60 to 150 mval/100 g.

It is preferred to use up to 5 percent by weight of phyllosilicates. Compared to Hua Wang et al., these composites are characterized by great strength and rigidity in the freshly molded and conditioned states, reduced water absorption, and improved thermooxidative stability.

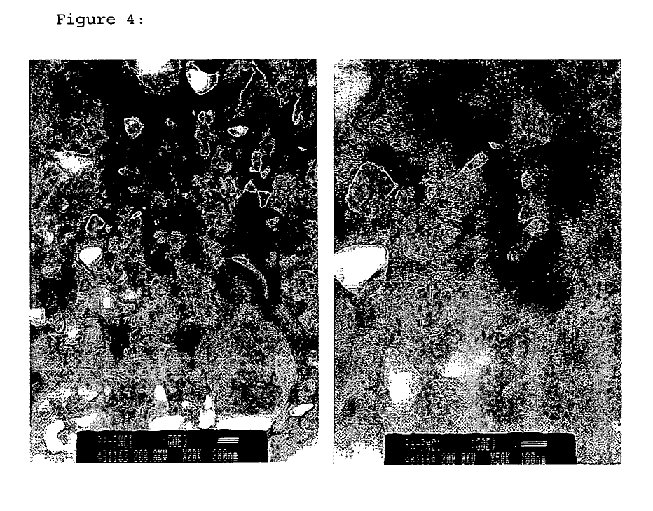

Two phases coexist in the nanocomposite blends according to the invention so that the organically intercalated phyllosilicates primarily disperse or exfoliate in the polyamide phase. Accumulation of the exfoliated layers at the boundary surface with the polypropylene phase was not observed using transmission electron microscopy (TEM) (FIG. 4). It is assumed that interaction between the polyamide and polypropylene phases is initiated by the intercalated and delaminated phyllosilicates.

A delaminated phyllosilicate (nanoclay, organically intercalated) in the meaning of this invention are swellable phyllosilicates in which the spacings between the silicate layers were enlarged by reaction with hydro-phobing agents. For montmorillonite, intercalation with suitable, preferably cationic intercalation components results in a layer spacing from 1.2 to 5.0 nm.

Phyllosilicates with a cation exchange capacity of at least 50, preferably 60 to 150 mval/100 g are preferred. The alkaline or earth alkaline metals that can be exchanged in these swellable phyllosilicates are replaced fully or in part by onium, ammonium, phosphonium, or sulfonium ions in an ion exchange reaction. Swellable phyllosilicates in which 50 to 200% of the replaceable inorganic cations are replaced by organic cations are particularly preferred.

Cationic nitrogen compounds suitable for intercalation are alkylammonium ions such as lauryl ammonium, myristyl ammonium, palmityl ammonium. Other preferred cationic nitrogen compounds are quaternary ammonium compounds such as distearyldimethyl ammoniumchloride and dimethyldistearylbenzyl ammoniumchloride.

Suitable bifunctional cationic nitrogen molecules include, first of all, ω-aminocarboxylic acids such as ω-aminoundecanoic acid, ω-aminododecanoic acid, ω-aminocaprylic acid, or ω-aminocaproic acid.

Other preferred nitrogen-containing intercalation components are caprolactam, lauryllactam, melamine, and oligomeric water-soluble amides.

It is preferred that all nitrogen-containing intercalation components are used in protonated form. All water-soluble organic and inorganic acids are suitable for protonation. Mineral acids such as hydrochloric acid, sulfuric acid, nitric acid and phosphoric acid, as well as acetic acid, formic acid, oxalic acid, and citric acid. Examples of suitable phosphonium ions include docosyl trimethyl phosphonium, hexatriacontyl tricyclohexyl phosphonium, octadecyl triethyl phosphonium, dicosyl triisobutyl phosphonium, methyltrinonyl phosphonium, ethyltrihexadecyl phosphonium, di-methyldidecyl phosphonium, diethyldioctadecyl phosphonium, octadecyl diethylallyl phosphonium, trioctylvinylbenzyl phosphonium, dioctydecylethyl hydroxyethyl phosphonium, docosyldiethyl dichlorobenzyl phosphonium, octylnonyldecylpropargyl phosphonium, triisobutyl perfluorodecyl phosphonium, eicosyltrihydroxymethyl phosphonium, triacontyltriscyanethyl phosphonium, and bistrioctylethylene diphosphonium.

Component d) Carboxylated Polyolefins

Suitable components D are polyolefins, particularly polyolefin copolymers that are functionalized with unsaturated mono/ or dicarboxylic acids or anhydrides.

They can be contained in the nanocomposite blends at up to 10 percent by weight, preferably at 0.1 to 1.9 percent by weight. Particularly suited are ethylene-ionomer copolymers, preferably ethylene acrylic acid or ethylene methacrylic acid copolymers that are fully or partly neutralized with metal ions. The ethylene ionomer can be a metal ion containing ethylene butadiene acrylic acid copolymer, ethylene methylacrylate maleic acid copolymer. The preferred metal ion is a Zn+, Na+, Mg+, or Zn-amine complex ion.

Other Additives

The polymer nanocomposite blends according to the invention may optionally contain common stabilizers and fillers selected from the groups of oxidation stabilizers, light stabilizers, process stabilizers, UV stabilizers, sliding agents, separating agents, pigments, dyes, flame retardants, fiber reinforcing fillers.

Examples of oxidation and process stabilizers are mixtures of at least two substances selected from the groups of metal halogenides such as sodium, potassium, lithium, zinc, and copper halogenides or organic compounds on phenol basis, hydroquinones, organic phosphite compounds.

Examples of UV stabilizers are resorcinols, salicylates, hindered amines, benzotriazoles and benzophenols.

Examples of sliding and separating agents include stearic acid, stearin alcohol, stearic acid amide, waxes, carboxylic acid esters, metal salts of carboxylic acid.

Examples of pigments are titane dioxide, cadmium sulfide, cadmium selenite, ultramarine blue, black.

An example of an organic dye is nigrosine.

Examples of flame retardants include organic halogen compounds, organic phosphor compounds, red phosphor, metal hydroxides.

Examples of fillers and reinforcing agents include glass fibers, glass pearls, glass flakes, talc, carbon fibers, kaolin, wollastonite, molybdenum sulfide, potassium titanate, barium sulfate, electroconducive black and aramide fibers.

In addition, other additives such as magnetizing substances, EMI masking agents, antibacterial and antistatic agents may be introduced.

The polymer nanocomposite blends are produced in that the components contain
a) polyamide (PA) from 55 to 95 percent by weight,
b) polypropylene (PP) from 4 to 40 percent by weight,
c) nanodisperse phyllosilicates from 1 to 9 percent by weight, and
d) up to 10 percent by weight, preferably from 0.1 to 1.9 percent by weight of carboxylated polyolefins, in particular copolymers of ethylene with unsaturated carboxylic acids
   and may additionally contain common stabilizers and fillers in excess of this composition of a total of 100 percent by weight and are compounded at temperatures above the melting points of the polymers involved in an extruder or kneader.

A variant of this process is to compound the components in one step.

Two-step methods are conceivable as well.

Components c) and d) can first worked into parts of component a) to form a master batch which is compounded in a second step with component b) and the remaining quantity of component a) and processed further.

In another embodiment, components d) and b) are first compounded in an extruder or kneader at temperatures above the melting points of the polymers involved to become a modified polypropylene, then component, a part of component a) is worked in to form a master batch which in a next step is compounded with the modified polypropylene and the remaining quantity of component a) and then processed further.

Another option is to compound components d) and b) in an extruder or kneader at temperatures above the melting points of the polymers involved to become a modified polypropylene and in a next step to compound the modified polypropylene with component a) and component d) and to continue processing.

The polymer nanocomposite blends according to the invention are particularly suited for use as extrudates, injection-molded parts, or fibers.

The intercalation components mentioned in the description of component c) act as hydrophobing agents and influence the surface tension of the phyllosilicates so that polarity and the overall surface energy value drop. Polarity and surface tension of the polyamide drop after compounding with polyamide. This ensures better intermixing and finer dispersion of the polypropylene phase in the nanocomposite blends as compared to pure PA 6/PP nanocomposite blends.

The TEM examination of the PA 6/PP nanocomposite blends according to the invention shows fine dispersion of the polypropylene phase. The particles have a size between 0.1 and 1 μm (FIG. 4a). FIG. 4b shows that the exfoliated phyllosilicates are mainly dispersed inside the polyamide matrix, and accumulation of the layers that form some kind of a card structure around the polypropylene particles is clearly visible. Increased concentration of the organophilic phyllosilicate at the boundary surface of the polyamide and polypropylene phases lowers the surface tension difference between the normally incompatible polymers.

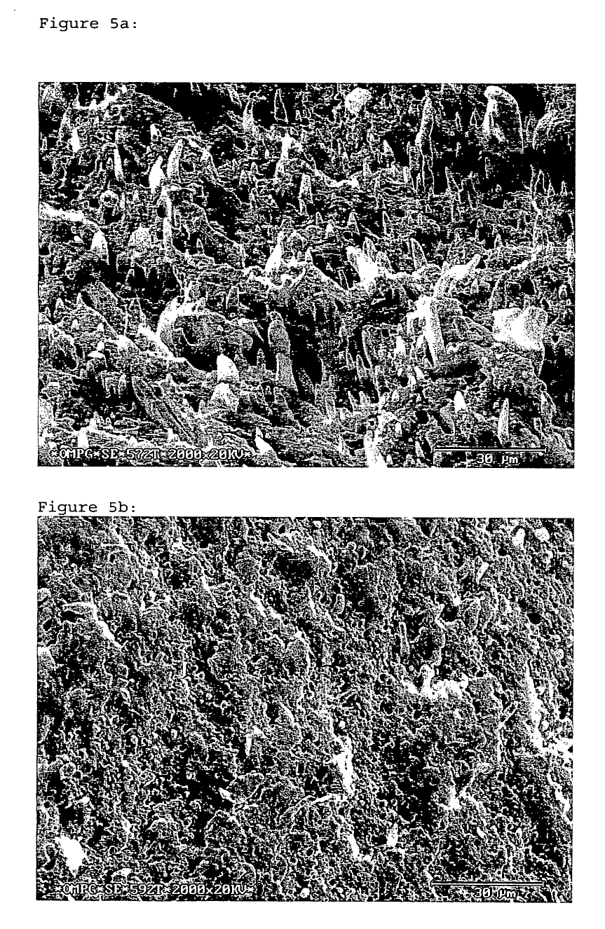

We also studied the morphology in the nanocomposite blends (on gold-plated cryofracture surfaces) with a scanning electron microscope (SEM). Larger structures were observed. The PP phase is distributed in the form of sticks in the PA/PP nanocomposite blends (FIG. 5a). After adding only 1 to 1.9% by wt. ethylene ionomer, it is no longer possible to distinguish the PP phase from the PA phase. The cryofracture surface appears as a solid surface with an uninterrupted PA/clay-PP boundary surface. The figure shows small PP particles embedded in the polyamide/clay matrix with a diameter less than 1 μm (FIG. 5b).

The nanocomposite blends according to the invention have excellent mechanical properties such as strength, rigidity, and notch-impact resistance in freshly molded and conditioned states as well as after storage at air temperature.

Compared to pure polyamide, the tensile modulus of elasticity is increased by up to 50% in the freshly molded state, and the increase can be up to 150% in the conditioned state. If compared to a polyamide/polypropylene blend of the respective composition, the increase is up to 70% in the freshly molded and up to 75% in the conditioned state. Water absorption of the described PA/PP nanocomposite blends after conditioning (typically at 23° C. and 95% humidity) is clearly below the value of the pure nanocomposite and the pure polyamide 6. The nanocomposite blends also show improved tensile moduli of elasticity by 150% as compared to pure polyamide in the saturated state and after being stored in water for more than 1800 hours.

After storage at temperatures above 100° C. (110, 120, 130 and 150° C.), the nanocomposite blends according to the invention show the slightest loss in strength.

The nanocomposite blends according to the invention show a clearly reduced loss in mechanical strength after temperature storage at 150° C. after adding small quantities of ethylene ionomer, particularly up to 1.9 percent by weight, particularly when using a low-molecular ethylene ionomer completely neutralized with Zn and without adding a heat stabilizer.

In addition to thermal stability, reduced water absorption and distinctively higher rigidity were detected in these nanocomposite blends in their conditioned state in accordance with ISO 1110 (50% relative humidity).

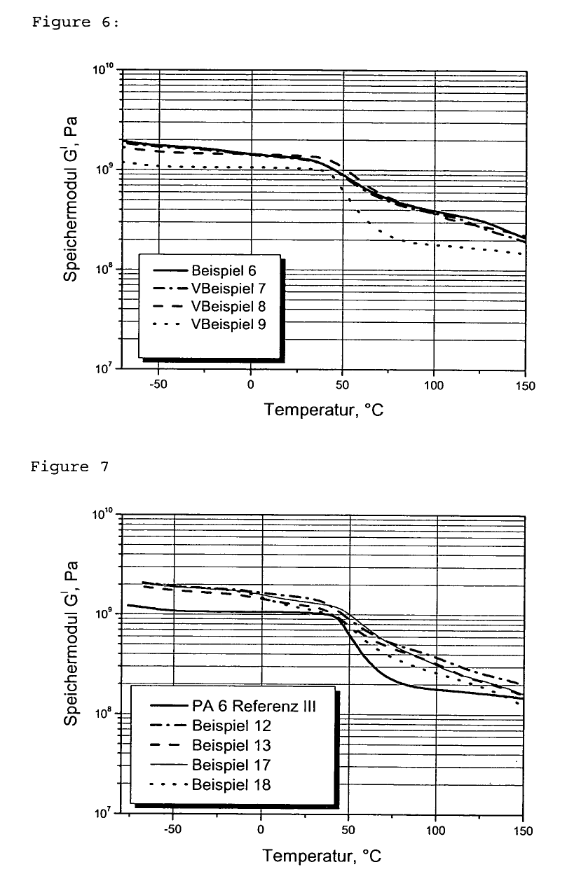

The storage modulus, as measured in a torsion test, of the nanocomposite blends according to the invention with 15 percent by weight of PP is similar to the one for PA 6 nanocomposite at a temperature range from 25 to 150° C. and is up to 100% higher at a temperature of 100° C. than that of pure polyamide 6 (FIG. 6). A slight decline of the storage modulus in the n nanocomposite blends according to the invention is found with increasing PP content but it remains above the storage modulus of pure polyamide 6 (FIG. 7).

The invention is explained in greater detail with reference to the examples below, to which however it is not limited:

### EXAMPLES 1 TO 7

### One-Step Method

PA/PP nanocomposite blends were produced at a L/D ratio of at least 40 using a twin-screw extruder (ZSK 25, Coperion Werner & Pfleiderer). The polymers and phyllosilicates intercalated with organic substances were added in the first zone using polymer or powder scales. The batch was compounded at temperatures from 220 to 260° C. and a speed of 400 min⁻¹. The compounded nanocomposite blends were made into test specimens using injection molders (Arburg Allrounder 320M 850-210).

The spacing between the silicate sheets was determined by WAXS analyses (WAXS=wide angle X-ray scattering). Based on this and on TEM recordings, conclusions were drawn regarding the degree of exfoliation or dispersion of the phyllosilicates. The distribution of polypropylene phase in the nanocomposite blends was evaluated based on TEM and SEM recordings.

(TEM=Transmission Electron Microscopy; SEM=Scanning Electron Microscopy)

The volumetric melt-flow indices of the parent components and of the nanocomposite blends were measured with a melt-flow index tester (by Göttfert) and listed as melt-flow indices with the examples.

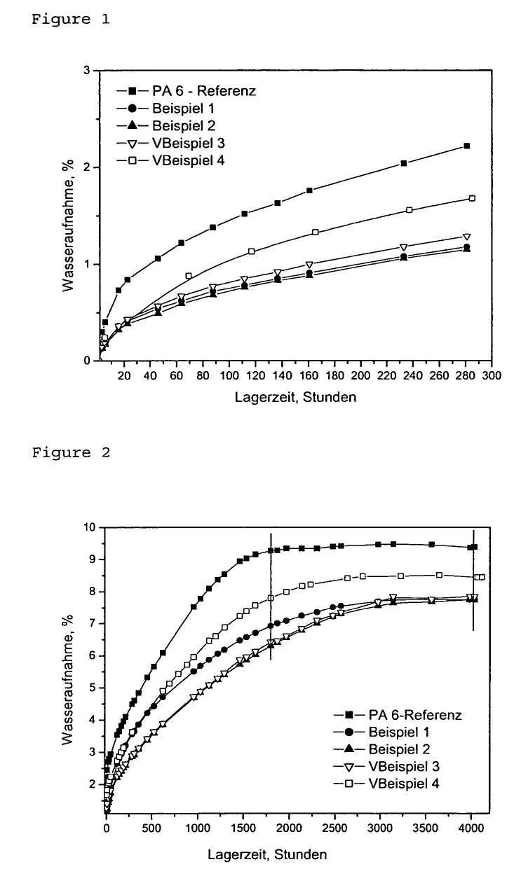

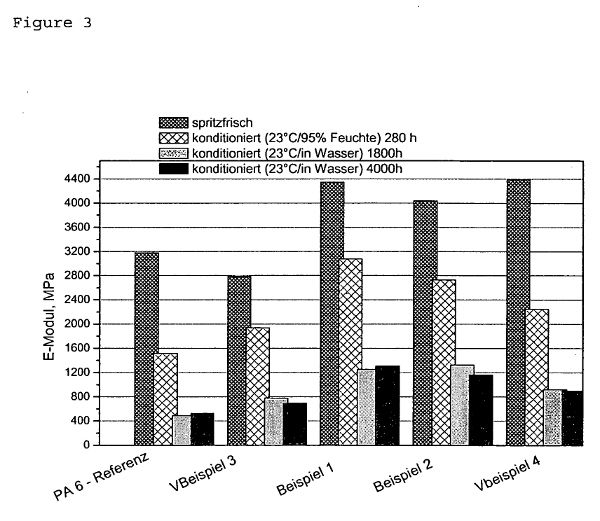

The mechanical properties of the nanocomposite blends were tested in the freshly molded and conditioned states using a tensile test according to DIN EN ISO 527 and notch-impact strength test according to DIN EN ISO 179/1eA. Thermostability (HDT) was measured according to ASTM D648. The samples in examples 1 to 4 were conditioned at a temperature of 23° C. and a humidity of 95% for a period of 280 hours (conditioning 1). Then some of the samples were tested in the tensile test while the rest was stored in water at room temperature until saturation was reached (conditioning 2). The composition of the nanocomposite blends is shown for each example. The properties are listed in Tables 1 to 4, water absorption is shown in FIGS. 1, 2, and the moduli of elasticity are shown in FIG. 3.

The dynamic-mechanical behavior of the nanocomposite blends in Examples 6 and 7 was tested using a RDA II torsion test device (by Rheometric Scientific) at a constant elongation of 0.1% and a frequency of 1 Hz. The storage modulus as a function of temperature is shown in FIG. 6.

Samples 6 and 7 were conditioned according to EN ISO 1110 at 70° C. and 62% relative humidity until their weight remained constant. The test rods of the samples in Examples 6 and 7 were also stored in circulating air ovens at 110° C., 120° C., 130° C., and 150° C. and subsequently tested for tensile properties.

The solution viscosity of polyamide 6 was measured in a 1% solution in sulfuric acid (96%) at 25° C.

### EXAMPLE 1

Polyamide 6 with a melt-flow index of 4.9(230° C./2.16 kg) and a relative solution viscosity of 3.45 (reference polyamide I), polypropylene with a melt-flow index of 5(230° C./2.16 kg), and octadecylamine-modified montmorillonite (such as Nanofil 848) were compounded at a weight ratio of 80/15/5.

### EXAMPLE 2

Polyamide 6 with a melt-flow index of 4.9(230° C./2.16 kg) and a relative solution viscosity of 3.45, polypropylene with a melt-flow index of 5(230° C./2.16 kg), and octadecylamine-modified montmorillonite (such as Nanofil 848) and aminododecanic acid-modified montmorillonite (such as Nanofil 784) were compounded at a weight ratio of 79.2/15.8/2.5/2.5.

### REFERENCE EXAMPLE 3

Polyamide 6 with a melt-flow index of 4.9(230° C./2.16 kg) and a relative solution viscosity of 3.45, polypropylene with a melt-flow index of 5(230° C./2.16 kg) were compounded at a weight ratio of 85/15.

### REFERENCE EXAMPLE 4

Polyamide 6 with a melt-flow index of 4.9(230° C./2.16 kg) and a relative solution viscosity of 3.45, and octadecylamine-modified montmorillonite (such as Nanofil 848) were compounded at a weight ratio of 96.8/3.2.

The results are shown in the tables below.

TABLE 1
Properties of the nanocomposite blends of the invention

| | | | | | Reference |
|---|---|---|---|---|---|
| | Example 1 | Example 2 | Ref. Ex. 3 | Ref. Ex. 4 | polyamide I |
| Clay | 5 | 5 | — | 3.2 | — |
| content | | | | | |
| in % | | | | | |
| E modulus | 4348 | 4036 | 2786 | 4392 | 3180 |
| in MPa | | | | | |
| HDT/A | 100 | 103 | 54.3 | 104 | 68 |
| ASTM | | | | | |
| D648 | | | | | |
| @1.8 MPa | | | | | |
| in ° C. | | | | | |

TABLE 2
Properties of the nanocomposite blends of the invention after
conditioning at 23° C. and 95% relative humidity
for a period of 280 hours

| | | | | Ref. | Reference |
|---|---|---|---|---|---|
| | Example 1 | Example 2 | Ref. Ex. 3 | Ex. 4 | polyamide I |
| Clay content | 5 | 5 | — | 3.2 | — |
| in % | | | | | |
| E modulus | 3077 | 2725 | 1941 | 2249 | 1516 |
| in MPa | | | | | |
| Water | 1.18 | 1.15 | 1.29 | 1.68 | 2.22 |
| absorption | | | | | |
| in % | | | | | |

TABLE 3
Water absorption of the nanocomposite blends of
the invention after conditioning at 23° C. in water.

| | | | | Ref. | Reference |
|---|---|---|---|---|---|
| | Example 1 | Example 2 | Ref. Ex. 3 | Ex. 4 | polyamide I |
| Clay content | 5 | 5 | — | 3.2 | — |
| in % | | | | | |
| Water | 7.7 | 7.7 | 7.8 | 8.4 | 9.4 |
| absorption | | | | | |
| in % | | | | | |

### EXAMPLE 5

Polyamide 6 with a melt-flow index of 22.3(230° C./2.16 kg) and a relative solution viscosity of 2.7 (reference polyamide II), polypropylene with a melt-flow index of 24(230° C./2.16 kg), and octadecylamine-modified montmorillonite (such as Nanofil 848) were compounded at a weight ratio of 80/15/5. The PA 6/PP nanocomposite blend showed improved mechanical and thermal properties, an E modulus increase of 43% and HDT increase of 73%.

| | | |
|---|---|---|
| Blend properties: | E modulus: | 3860 MPa |
| | HDT (1.8 MPa): | 95° C. |
| Properties of the | E modulus: | 2700 MPa |
| ref. Polyamide II: | HDT (1.8 MPa): | 55° C. |

### REFERENCE EXAMPLE 6

Polyamide 6 with a melt-flow index of 6.6(230° C./2.16 kg) and a relative solution viscosity of 3.2 (reference polyamide III), and octadecylamine-modified montmorillonite (such as Nanofil 848) were compounded at a weight ratio of 95/5. 0.2% of Irganox B1171 (a blend of heat and process stabilizers) were added to the mixture.

### REFERENCE EXAMPLE 7

Polyamide 6 with a melt-flow index 6.6(230° C./2.16 kg) and relative solution viscosity of 3.2 (reference polyamide III) was processed while adding 0.2% Irganox B1171 (a blend of heat and process stabilizers).

TABLE 4
Properties of PA/PP nanocomposite blends

| | | | | | | | Reference |
|---|---|---|---|---|---|---|---|
| | Ref. Example 6 | Ref. Example 7 | Example 8 | Example 10 | Example 12 | Example 14 | polyamide III |
| PA 6, % by wt. | 94.8 | 99.8 | 80 | 79 | 78.2 | 78.2 | 100 |
| PP, % by wt. | — | — | 15 | 15 | 15 | 15 | — |
| Clay content, % by wt. | 5 | — | 5 | 5 | 5 | 5 | — |
| Ionomer Ac, % by wt. | — | — | — | 1 | — | | — |
| Ionomer Ac1, % by wt. | — | — | — | — | 1.8 | | — |
| Ionomer Sr, % by wt. | — | — | — | — | — | 1.8 | — |
| Irganox, % by wt. | 0.2 | 0.2 | — | — | — | — | — |
| MVI (230° C./2.16 kg), | 3.6 | 6.6 | 2.8 | 1.6 | 2.4 | 1.5 | 6.6 |
| cm³/10 min | | | | | | | |
| Tensile strength, MPa | 92.9 | 79 | 73 | 72 | 75 | 76 | 79 |
| Retention of tensile strength | 16.7 | 27.5 | 30 | 52 | 45 | 48 | <25 |
| after 336 hours at 150° C., % | | | | | | | |
| Tensile elongation, % | 3.5 | 3.8 | 3.1 | 3.2 | 3.2 | 3.5 | 4.2 |
| Breaking elongation, % | | | 4.6 | 6 | 4.6 | 6 | 29.5 |
| E modulus, MPa | 4140 | 3034 | 3905 | 3810 | 3580 | 3570 | 2720 |
| Notch-impact strength, | 4 | 3.67 | 4 | 4.2 | 4 | 4.3 | 2.5 |
| 23° C., kJ/m² | | | | | | | |
| Water absorption acc. to EN | 2.4 | 2.5 | 1.9 | 1.8 | 2.1 | 2.1 | 2.5 |
| ISO 1110, (50%/RH), % | | | | | | | |
| E modulus, (50% RH) MPa | 1760 | 936 | 1900 | 1920 | 1740 | 1670 | 930 |

### EXAMPLES 8 TO 16

### Two-Step Method

The PA/PP nanocomposite blends were produced at a L/D ratio of at least 40 using a twin-screw extruder (ZSK 25/40, Coperion Werner & Pfleiderer). The polymers and phyllosilicates intercalated with organic substances were added in the first zone using polymer or powder scales. The batch was compounded at zone temperatures from 220 to 260° C. and a speed of 250 and 400 min⁻¹ respectively. First, the master batches PA 6/clay without or with ethylene acrylic acid or ethylene methacrylic acid ionomer were prepared. Then the master batches were compounded with PP and PA 6. The overall throughput in master batch production and compounding was 6 kg/h.

The compounded nanocomposite blends were made into test specimens using injection molders (Arburg Allrounder 320M 850-210).

The spacing between the silicate sheets in the master batches was determined by WAXS analyses (WAXS=wide angle X-ray scattering).

The mechanical properties of the nanocomposite blends were tested (in freshly molded and conditioned states) using a tensile test according to DIN EN ISO 527 and notch-impact strength test according to DIN EN ISO 179/1eA.

The dynamic-mechanical behavior of the nanocomposite blends was tested using a RDA II torsion test device (by Rheometrics) at a constant elongation of 0.1% and a frequency of 1 Hz. The composition of the nanocomposite blends is shown in the examples below and listed in Tables 4 and 5, the storage modulus as a function of temperature is shown in FIG. 7.

The samples used in Examples 8 and 16 were conditioned according to EN ISO 1110 at 70° C. and 62% relative humidity until their weight remained constant. Test rods of samples 10 to 15 were stored in the circulating air oven at 150° C. and subsequently subjected to a tensile test.

The solution viscosity of polyamide 6 was measured in a 1% solution in sulfuric acid (96%) at 25° C.

### EXAMPLE 8

Polyamide 6 with a melt-flow index of 6.6(230° C./2.16 kg) and a relative solution viscosity of 3.2 (reference polyamide III), polypropylene with a melt-flow index of 6 (230° C./2.16 kg), and octadecylamine-modified montmorillonite (such as Nanofil 848) were used.

First, a master batch of PA 6 and clay at an 80/20 weight ratio was prepared. WAXS analyses showed that the spacings between the silicate sheets widened by more than 4.5 nm. The master batch was then compounded with PA 6 and PP so that the final concentration of the components in the PA 6/PP/clay mixture was at a 80/15/5 weight ratio.

### EXAMPLE 9

The same procedures and materials as in Example 10 were used. The final concentration of the components in the PA 6/PP/clay mixture was at a weight ratio of 70/25/5.

### EXAMPLE 10

Polyamide 6 with a melt-flow index of 6.6(230° C./2.16 kg) and a relative solution viscosity of 3.2 (reference polyamide III), polypropylene with a melt-flow index of 6 (230° C./2.16 kg), a low-molecular ethylene acrylic acid copolymer (such as Aclyn 295) completely neutralized with Zn (here called ionomer Ac) and octadecylamine-modified montmorillonite (such as Nanofil 848) were used.

First, a master batch of PA 6, ionomer Ac, and clay at a 75/5/20 weight ratio was prepared. WAXS analyses showed that the spacings between the silicate sheets widened by more than 4.26 nm. The master batch was then compounded with PA 6 and PP so that the final concentration of the components in the PA 6/PP/ionomer Ac/clay mixture was at a 79/15/1/5 weight ratio.

### EXAMPLE 11

The same procedures and materials as in Example 12 were used. The final concentration of the components in the PA 6/PP/ionomer Ac/clay mixture was at a weight ratio of 69/25/1/5.

### EXAMPLE 12

Polyamide 6 with a melt-flow index of 6.6(230° C./2.16 kg) and a relative solution viscosity of 3.2 (reference polyamide III), polypropylene with a melt-flow index of 6 (230° C./2.16 kg), a low-molecular ethylene acrylic acid copolymer (such as Aclyn 291) partly neutralized with Zn (here called ionomer Ac1) and octadecylamine-modified montmorillonite (such as Nanofil 848) were used.

First, a master batch of PA 6, ionomer Ac1, and clay at a 72.5/7.5/20 weight ratio was prepared. WAXS analyses showed that the spacings between the silicate sheets widened by more than 4.26 nm. The master batch was then compounded with PA 6 and PP so that the final concentration of the components in the PA 6/PP/ionomer Ac1/clay mixture was at a 78.2/15/1.8/5 weight ratio.

### EXAMPLE 13

The same procedures and materials as in Example 14 were used. The final concentration of the components in the PA 6/PP/ionomer Ac1/clay mixture was at a weight ratio of 69.5/25/1.5/4.

### EXAMPLE 14

Polyamide 6 with a melt-flow index of 6.6(230° C./2.16 kg) and a relative solution viscosity of 3.2 (reference polyamide III), polypropylene with a melt-flow index of 6 (230° C./2.16 kg), a high-molecular ethylene methacrylic acid copolymer (such as Surlyn) partly neutralized with Zn (here called ionomer Sr) and octadecylamine-modified montmorillonite (such as Nanofil 848) were used.

First, a master batch of PA 6, ionomer Sr, and clay at a 72.5/7.5/20 weight ratio was prepared. WAXS analyses showed that the spacings between the silicate sheets widened by more than 4.3 nm. The master batch was then compounded with PA 6 and PP so that the final concentration of the components in the PA 6/PP/ionomer Sr/clay mixture was at a 78.2/15/1.8/5 weight ratio.

### EXAMPLE 15

The same procedures and materials as in Example 16 were used. The final concentration of the components in the PA 6/PP/ionomer Sr/clay mixture was at a weight ratio of 69.5/25/1.5/4.

### EXAMPLE 16

The same procedures and materials as in Example 16 were used. The final concentration of the components in the PA 6/PP/ionomer Sr/clay mixture was at a weight ratio of 55.9/40/1.1/3.

TABLE 5
Properties of PA/PP nanocomposite blends

| | | Example | Example | Example | |
|---|---|---|---|---|---|
| | Example 9 | 11 | 13 | 15 | Example 16 |
| PA 6, % by wt. | | 69 | 69.5 | 69.5 | 55.9 |
| PP content, | 25 | 25 | 25 | 25 | 40 |
| % by wt. | | | | | |
| Clay content, | 5 | 5 | 4 | 4 | 3 |
| % by wt. | | | | | |
| Ionomer Ac, | — | 1 | — | — | — |
| % by wt. | | | | | |
| Ionomer Ac1, | — | — | 1.5 | — | — |
| % by wt. | | | | | |
| Ionomer Sr, | — | — | — | 1.5 | 1.1 |
| % by wt. | | | | | |
| MVI (230° C./2.16 kg), | 2.6 | 1.4 | 2.8 | 1.5 | 2.7 |
| cm³/10 min | | | | | |
| Tensile strength, | 63 | 63 | 64 | 67 | 57 |
| MPa | | | | | |
| Retention of | 55 | 83 | 80 | 58 | 63 |
| tensile strength | | | | | |
| after 336 hours | | | | | |
| at 150° C., % | | | | | |
| Tensile elongation, % | 2.9 | 3.2 | 2.9 | 3.4 | 3.8 |
| Breaking | 4 | 5 | 3.4 | 5.3 | 4.3 |
| elongation, % | | | | | |
| E modulus, MPa | 3500 | 3100 | 3311 | 3190 | 2870 |
| Notch-impact | 3.4 | 4.2 | 4.2 | 3.8 | 5.2 |
| strength, 23° C., | | | | | |
| kJ/m² | | | | | |
| Water absorption | 1.5 | 1.36 | 2 | 2 | 1.44 |
| acc. to EN ISO | | | | | |
| 1110, | | | | | |
| (50%/RH), % | | | | | |
| E modulus, | 1980 | 2070 | 1750 | 1670 | 1640 |
| (50% RH) MPa | | | | | |

FIGS. 1 to 7
FIG. 1: Water absorption of the nanocomposite blends at 23° C. and 95% relative humidity as a function of storage time
FIG. 2: Water absorption of the nanocomposite blends at 23° C. in water as a function of storage time
FIG. 3: E moduli of the nanocomposite blends in freshly molded and conditioned states (23° C./95% relative humidity—after 280 hours; 23°/in water after 1800 hours and after 4000 hours)
FIG. 4: TEM recording of ultrathin slices of PA 6/PP nanocomposite blends: a) contrasted, b) uncontrasted
FIG. 5: SEM recordings of cryofracture surfaces of the test rods of PA 6/PP nanocomposite blends: a) without additional compatibilization, b) with 1.8% by wt.
   ethylene ionomer copolymer
FIG. 6: Storage modulus of PA/PP nanocomposite blends according to the invention as a function of temperature
FIG. 7: Storage modulus of PA/PP nanocomposite blends according to the invention as a function of temperature

1.-10. (canceled)

11. Nanocomposite blends containing
a) polyamide (PA) from 55 to 95% by wt.,
b) polypropylene (PP) from 4 to 40% by wt.,
c) nanodisperse phyllosilicates from 1 to 9% by wt. selected from the group of natural sodium montmorillonite, hectorite, bentonite, or synthetic mica modified with onium ions and having a cation exchange capacity or 60 to 150 mval/100 g,
d) polyolefin copolymers, especially copolymers of ethylene with unsaturated carboxylic acids, up to 1.9% by wt., that may contain common stabilizers and fillers in addition to this composition of 100% by wt. total.

12. The polymer nanocomposite blends according to claim 11 wherein component a) is a polyamide 6 with a solution viscosity from 2.2 to 4.0, preferably from 2.4 to 3.5, the solution viscosity being measured in a 1% solution of 96% sulfuric acid at 25° C.

13. The polymer nanocomposite blends according to claim 11 wherein component b) is a polypropylene with a melt-flow index from 1 to 110, preferably from 5 to 30 ccm/10 min (230° C./2.16 kg).

14. The polymer nanocomposite blends according to claim 12 wherein component b) is a polypropylene with a melt-flow index from 1 to 110, preferably from 5 to 30 ccm/10 min (230° C./2.16 kg).

15. The polymer nanocomposite blends according to claim 11 wherein component d) is contained in the nanocomposite blends at 0.1 to 1.9% by wt. and preferably is an ethylene acrylic acid copolymer or an ethylene methacrylic acid copolymer that is partly or fully neutralized with metal ions.

16. The polymer nanocomposite blends according to claim 12 wherein component d) is contained in the nanocomposite blends at 0.1 to 1.9% by wt. and preferably is an ethylene acrylic acid copolymer or an ethylene methacrylic acid copolymer that is partly or fully neutralized with metal ions.

17. The polymer nanocomposite blends according to claim 13 wherein component d) is contained in the nanocomposite blends at 0.1 to 1.9% by wt. and preferably is an ethylene acrylic acid copolymer or an ethylene methacrylic acid copolymer that is partly or fully neutralized with metal ions.

18. The polymer nanocomposite blends according to claim 14 wherein component d) is contained in the nanocomposite blends at 0.1 to 1.9% by wt. and preferably is an ethylene acrylic acid copolymer or an ethylene methacrylic acid copolymer that is partly or fully neutralized with metal ions.

19. A method for producing polymer nanocomposite blends wherein the components
a) polyamide (PA) from 55 to 95% by wt.,
b) polypropylene (PP) from 4 to 40% by wt.,
c) nanodisperse phyllosilicates from 1 to 9% by wt. selected from the group of natural sodium montmorillonite, hectorite, bentonite, or synthetic mica modified with onium ions and having a cation exchange capacity or 60 to 150 mval/100 g,
d) polyolefin copolymers, especially copolymers of ethylene with unsaturated carboxylic acids, up to 1.9% by wt., that may contain common stabilizers and fillers in addition to this composition of 100% by wt. total are compounded at temperatures above the melting points of the polymers involved in an extruder or kneader.

20. The method according to claim 19 wherein the components are compounded in one step.

21. The method according to claim 19 wherein components c) and d) are first worked into parts of component a) to form a master batch which is compounded in a second step with component b) and the remaining quantity of component a) and then processed further.

22. The method according to claim 19 wherein components d) and b) are first compounded in an extruder or kneader at temperatures above the melting points of the polymers involved and component c) and a part of component a) are worked in to produce a master batch which in a next step is compounded with the modified polypropylene and the remaining quantity of component a) and then processed further.

23. The method according to claim 19 wherein components d) and b) are compounded in an extruder or kneader at temperatures above the melting points of the polymers involved to become a modified polypropylene and in a next step this modified polypropylene compounded with component a) and component d) and then processed further.

24. Use of the nanocomposite blends according to any one of claims 11 to 18, produced according to one of claims 19-23, as extrudates, injection-molded parts, or fibers.
